(19) United States
(12) Patent Application Publication
(10) Pub. No.: US 2015/0234943 A1
(43) Pub. Date: Aug. 20, 2015

(54) SHADE CALCULATION FOR SOLAR INSTALLATION

(71) Applicant: SolarCity Corporation, San Mateo, CA (US)

(72) Inventors: Travis Brier, San Francisco, CA (US); Maciej Kicinski, Santa Clara, CA (US); Michael Lazzareschi, Los Angeles, CA (US); Damien Scott, Daly City, CA (US)

(73) Assignee: SolarCity Corporation, San Mateo, CA (US)

(21) Appl. No.: 14/181,440

(22) Filed: Feb. 14, 2014

(51) Int. Cl. G06F 17/50; G06K 9/00; G01C 11/04; G06Q 50/06; G06T 7/00

(52) U.S. Cl. CPC G06F 17/5004; G06Q 50/06; G06T 7/0061; G06T 7/0075; G01C 11/04; G06K 9/00637; G06T 2207/10032

(57) ABSTRACT

In one embodiment, a method outputs a first image of a site for a solar installation. The first image allows a distance and correlating values to be defined. A first input for the first image is used to define the distance from the measurement position of the solar installation to the set of obstructions. The method then outputs a second image of the site for the solar installation. The second image allows a height and the correlating values to be defined. A second input for the second image is used to define the height of the set of obstructions. Then, the method generates a three dimensional model of the site. A path of solar light is overlaid at a set of time intervals to determine when the set of obstructions obstruct the solar light from the solar installation at the installation location and a shade calculation is performed.

### BACKGROUND

Solar panel installations are typically installed on various structures, such as the roofs of buildings or homes. Before installation, a user typically determines an optimal position to install the installation. The optimal position may be a point on the roof where the solar installation produces the most energy throughout the year. One factor that may affect the amount of energy produced is the amount of shade that falls on the solar installation throughout the year, which affects the production of energy due to the Sun's rays being blocked. For example, obstructions, such as trees or buildings, may exist around the installation point that may obstruct the rays of the Sun at certain points during the day/year. The amount of shade at a particular installation location should be taken into account when determining the optimal installation location for the solar panels.

### SUMMARY

In one embodiment, a method outputs a first image of a site for a solar installation. The first image is in a perspective that allows a distance from a measurement position of the solar installation to a set of obstructions and a set of correlating values to be defined. A first input for the first image is received and used to define the distance from the measurement position of the solar installation to the set of obstructions. The method then outputs a second image of the site for the solar installation. The second image is in a perspective that allows a height of the set of obstructions and the set of correlating values to be defined. A second input for the second image is received and used to define the height of the set of obstructions. Then, the method generates a three dimensional model of the site that models an installation location of the solar installation and the set of obstructions where the set of obstructions are generated based on the distance, height, and the set of correlating values. A path of solar light is overlaid in the three dimensional model at a set of time intervals to determine when the set of obstructions obstruct the solar light from the solar installation at the installation location and a shade calculation for the solar installation is performed based on the when the set of obstructions obstruct the solar light from the solar installation at the measurement position.

In one embodiment, a non-transitory computer-readable storage medium contains instructions, that when executed, control a computer system to be configured for: outputting a first image of a site for a solar installation, the first image in a perspective that allows a distance from a measurement position of the solar installation to a set of obstructions and a set of correlating values to be defined; receiving a first input for the first image, the first input used to define the distance from the measurement position of the solar installation to the set of obstructions; outputting a second image of the site for the solar installation, the second image in a perspective that allows a height of the set of obstructions and the set of correlating values to be defined; receiving a second input for the second image, the second input used to define the height of the set of obstructions; generating a three dimensional model of the site that models an installation location of the solar installation and the set of obstructions, wherein the set of obstructions are generated based on the distance, height, and the set of correlating values; overlaying a path of solar light in the three dimensional model at a set of time intervals to determine when the set of obstructions obstruct the solar light from the solar installation at the installation location; and performing a shade calculation for the solar installation based on the when the set of obstructions obstruct the solar light from the solar installation at the measurement position.

In one embodiment, an apparatus includes: one or more computer processors; and a non-transitory computer-readable storage medium comprising instructions, that when executed, control the one or more computer processors to be configured for: outputting a first image of a site for a solar installation, the first image in a perspective that allows a distance from a measurement position of the solar installation to a set of obstructions and a set of correlating values to be defined; receiving a first input for the first image, the first input used to define the distance from the measurement position of the solar installation to the set of obstructions; outputting a second image of the site for the solar installation, the second image in a perspective that allows a height of the set of obstructions and the set of correlating values to be defined; receiving a second input for the second image, the second input used to define the height of the set of obstructions; generating a three dimensional model of the site that models an installation location of the solar installation and the set of obstructions, wherein the set of obstructions are generated based on the distance, height, and the set of correlating values; overlaying a path of solar light in the three dimensional model at a set of time intervals to determine when the set of obstructions obstruct the solar light from the solar installation at the installation location; and performing a shade calculation for the solar installation based on the when the set of obstructions obstruct the solar light from the solar installation at the measurement position.

The following detailed description and accompanying drawings provide a better understanding of the nature and advantages of particular embodiments.

### BRIEF DESCRIPTION OF THE DRAWINGS

FIG. 1 depicts a computing system for performing a shade calculation according to one embodiment.

FIG. 2A depicts an example of the first image according to one embodiment.

FIG. 2B depicts a simplified flowchart of a method for defining the distance to a set of obstructions according to one embodiment.

FIG. 3A shows an example of the second image according to one embodiment.

FIG. 3B depicts a simplified flowchart of a method for calculating the height according to one embodiment.

FIG. 4 depicts a simplified flowchart of a method for generating the 3-D model of the site according to one embodiment.

FIG. 5A shows an example of the 3-D model of the site and how rays are determined to be obstructed according to one embodiment.

FIG. 5B shows an example of the 3-D model of the structure in which the solar installation will be installed according to one embodiment.

FIG. 5C shows a more detailed example of the 3-D model of the site according to one embodiment.

FIG. 6 depicts a simplified flowchart of a method for performing the shade calculation using the first method according to one embodiment.

FIG. 7A depicts a simplified flowchart of the second method for calculating shade according to one embodiment.

FIG. 7B shows an example of a shade calculation report according to one embodiment.

FIG. 8 depicts an example of a system for generating a shade calculation report according to one embodiment.

FIG. 9 illustrates an example of a special purpose computer system configured with shade calculator according to one embodiment.

### DETAILED DESCRIPTION

Described herein are techniques for a shade calculation system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Particular embodiments provide a method for performing a shade calculation for a solar installation. Particular embodiments use a first image and a second image to generate a three dimensional (3-D) model of a solar installation site. For example, the first image may be an image from one perspective, such as an aerial image, of the site where the solar installation will be installed. The second image may be an image from another perspective, such as a panoramic image that is taken at the site. The first image allows particular embodiments to determine a distance from a measurement position and an azimuth from a reference for the solar installation to obstructions, such as trees, other buildings, etc. The second image allows particular embodiments to define a height of the set of obstructions and the azimuth from the reference for the set of obstructions.

After determining the distance, height, and azimuths, particular embodiments generate the three-dimensional model to represent the site. For example, the 3-D model models the structure (e.g., house) in which the solar installation will be installed and the set of obstructions in the site. Then, solar path is overlaid on the three-dimensional model over a set of time intervals, such as hourly time intervals throughout the year. Particular embodiments can determine when the set of obstructions obstruct the solar light (e.g., the Sun's rays) from reaching the solar installation. Based on which rays are obstructed, particular embodiments can then perform a shade calculation that summarizes the effect of shade on the solar installation. By building the three-dimensional model, particular embodiments also allow a user to change the installation location of the solar installation to anywhere in the 3-D model and perform the shade calculation from the changed position.

### Overview

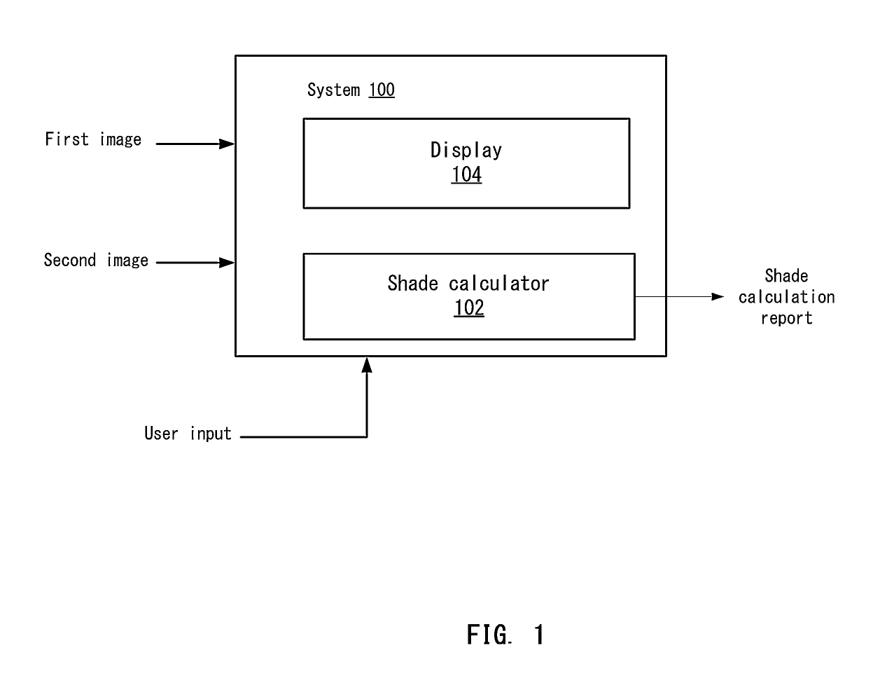

FIG. 1 depicts a computing system 100 for performing a shade calculation according to one embodiment. Computing system 100 may include a shade calculator 102 and a display 104. Shade calculator 102 receives a first image and a second image and outputs a shade calculation report using inputs for the first image and the second image. The shade calculation report may estimate the shade experienced by a solar installation. The solar installation may be any device that can convert solar light into energy, such as solar panels or arrays. For example, a solar panel includes multiple solar photovoltaic modules electrically connected and mounted on the panel or array. Each module uses solar light (e.g., the Sun's rays) to produce electricity. The solar installation may be installed on a structure, such as a roof of a house or building. In other examples, the solar installation may be installed on a mounting structure on the ground without being installed on the roof of a building. As discussed above, the installation position affects the amount of shade seen by the solar installation and it is desirable to estimate the amount of shade to determine an optimal position to install the solar installation.

The following will describe the first image and the second image. However, a different number of images may be used. The purpose of the first image is to determine the distance from a measurement position and an azimuth from a reference. The purpose of the second image is to determine the height of the set of obstructions and the azimuth from the reference. It is possible to one image or more than two images may also be used. For example, multiple second images may be used to determine the height of the set of obstructions. Also, a single image in which the distance, height, and azimuth could be defined can be used.

The first image may be an image of the site in which the solar installation will be installed. A measurement position in the image may be a position in which the second image was taken from. In one embodiment, the perspective of the first image may be such that the distance from the measurement position to the set of obstructions can be defined. For example, the first image may be an aerial image, such as a satellite image. The perspective of the first image shows a site plan of the surrounding area for the measurement position to allow for the distance from the installation location to the set of obstructions to be defined. As will be discussed in more detail below, user input for the first image may be used to determine a distance of obstructions to the measurement position and the azimuth for the obstructions. Also, in one embodiment, the first image may be received from a third party source, such as mapping software, mapping applications, or websites.

The second image may be an image from a perspective that allows the height of the set of obstructions to be defined. For example, a capture device may capture an image from the installation location, such as a user may take a photo from the measurement position or a position substantially near the measurement position. In one example, one or more photos may be taken on a roof of a building in which the solar installation will be installed. In one embodiment, a panoramic photo (360° or less) may be taken using a capture device, such as a camera or cellular phone. As will be discussed in more detail below, user input for the second image is used to determine the height and azimuth for the obstructions.

In one embodiment, shade calculator 102 outputs the first image and the second image on display 104. A user can then review the first image and provide input from the first image that defines the distance from the measurement position. For example, as described in more detail below, the user input may define a location of the obstructions by providing a line that defines the centerline of the obstructions. Shade calculator 102 can then determine the distance from the measurement position to the lines for the obstructions. Also, shade calculator 102 may also determine the azimuth based on the user input. The azimuth is used as a correlating value that allows information from the first image to be correlated to information from the second image. In one embodiment, the azimuth is an angle from a reference to the obstruction. The reference may be a direction that can be referenced in both the first image and the second image, such as the southern direction, or another reference point, such as where the Sun is at the time the image is taken. As will be described below, the azimuth is defined in both the first image and the second image and used as a common reference point to generate the obstructions. Also, correlating values other than the azimuth may be used. The correlating values would be values present in both the first image and the second image that can correlate corresponding values of the height and distance.

Also, shade calculator 102 may use the second image to determine the height and azimuth for the obstructions in the second image. For example, shade calculator 102 may receive a user input from the user that defines the height of the obstructions in the second image. In one example, the user may trace the top of the outline of the obstructions in the second image. Shade calculator 102 then determines the height of the obstructions based on the input. In addition to the height, shade calculator 102 may also determine the azimuth based on the user input. The azimuth is an angle from the reference to the obstruction. The above process will be described in more detail below.

Although user input is described as being provided to determine the distance from the installation location to the obstructions, the azimuths, and the height of the obstructions, particular embodiments may automatically determine these inputs also. For example, shade calculator 102 may analyze characteristics of the first image and the second image to determine the distance, azimuths, and height of the obstructions. In one example, to determine the height of obstructions, shade calculator 102 may analyze the contrast in color in the second image to determine the top of the obstructions. As such, “input” may be a user input or an input that is automatically determined via analysis. Also, although a user input is described for discussion purposes, the user input may be interchanged with automatic analysis.

Shade calculator 102 uses the user input to perform a shade calculation. In the calculation, shade calculator 102 generates the 3-D model of the site using the user input. The 3-D model models the structure and the obstructions. Then, shade calculator 102 may determine when solar access (e.g., the rays from the Sun) is obstructed by the set of obstructions at various time intervals (e.g., hourly throughout the year) using the 3-D model. Shade calculator 102 then performs a shade calculation to estimate the effect of shade on the solar installation at one or more installation locations. In one embodiment, shade calculator 102 may use different calculations to estimate the shade, which will be discussed in more detail below.

The shade calculation may be used to determine whether the installation location is an optimal position for placing the solar installation. For example, a location that is situated in a large amount of shade, which means the Sun's rays are blocked for a large period of time over the year, may not be an optimal installation location.

A user may check multiple installation locations to determine the optimal location. By generating the 3-D model, shade calculator 102 may calculate the shade percentage from any point in the 3-D model without requiring additional pictures from the other positions. This allows a user to change the installation locations of the solar installation without having to take additional photos or use different images other than the first image and the second image. Further, the shade calculation may be performed for multiple modules in the solar installation that reside at different positions. Thus, a different photo does not have to be taken at the different position to calculate the shade for the different installation locations. However, in particular embodiments, a user may change the location to anywhere in the 3-D model, and shade calculator 102 can calculate the shade from that location. This provides a very convenient and time-saving approach to determining an optimal position for a solar installation.

The following will now describe the process to perform the shade calculation in more detail.

### First Image

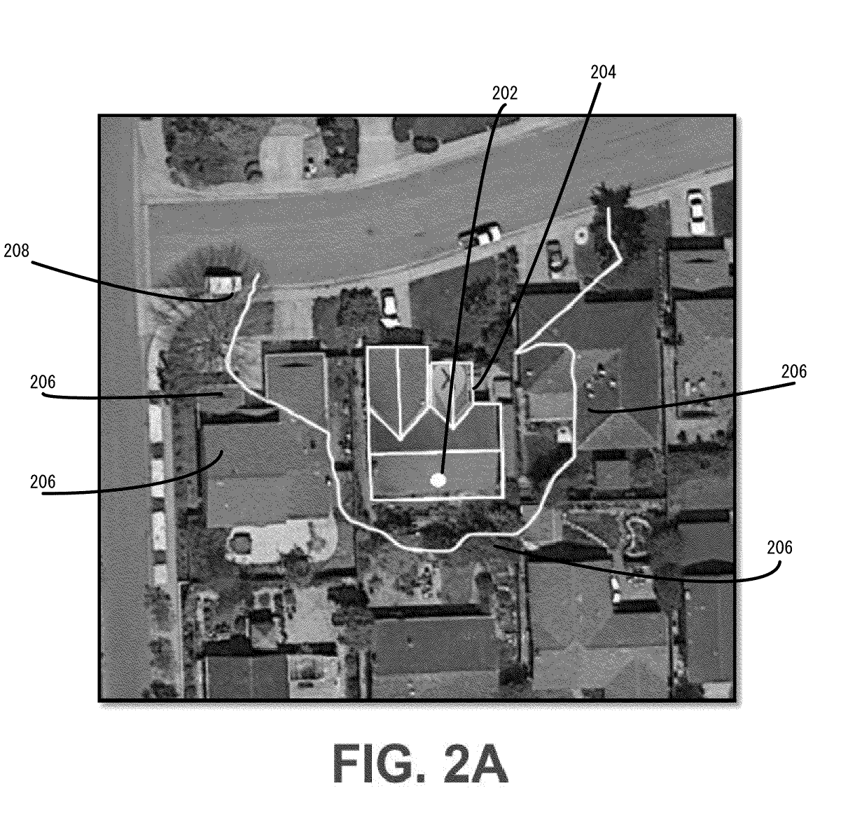

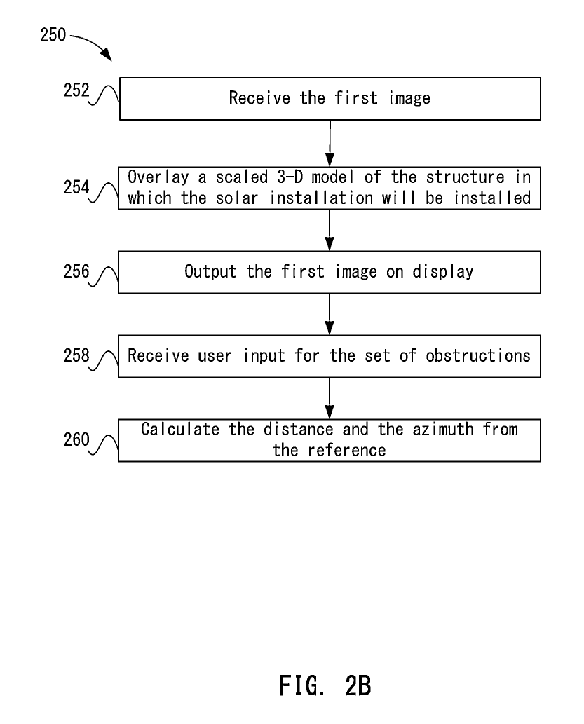

FIG. 2A depicts an example of the first image according to one embodiment. At 202, the measurement position for the solar installation is shown. The measurement position is where the second image was taken from. The measurement position is shown on a structure at 204 that is a house in this embodiment. The house has been outlined by a 3-D model and the measurement position is found on the roof of the 3-D model of the house. Various obstructions may be found around the measurement position. For example, obstructions shown at 206 include trees and buildings that may obstruct the Sun's rays from reaching the solar installation at certain times during the year.

To allow a user to define the distance to the obstructions, shade calculator 102 may display the first image on display 104. The perspective of the first image allows a user to define the distance from the measurement position to the obstructions. The user may then provide inputs that shade calculator 102 uses to determine the distance to the obstructions from the measurement position. As shown at 208, shade calculator 102 has received user input on the second image to mark the obstructions. In one embodiment, the user input defines a position of the obstructions in the second image, such as a center line of the obstructions. Although the center line is discussed, a user may provide user input at other positions of the obstructions. For example, instead of a line along the center line of the obstructions, a user may provide a mark (e.g., a circle) that surrounds the obstructions. Shade calculator 102 may then use the circle to determine a center line, or may just use the circle to calculate the distance. Using the center line example, shade calculator 102 may calculate the distance from the measurement position to the line. Also, shade calculator 102 uses the azimuth from the reference to associate each distance calculation with an azimuth. For example, shade calculator 102 may record the distance of 10 yards at the azimuth of 5 degrees from the Southern direction for one reading. A second reading may be a distance of 12 yards at an azimuth of 6 degrees. The distance and azimuth will be used to generate a model of the obstruction as will be described in more detail below. The above process may be used to provide user input for as many obstructions as are found in the site plan. For example, other obstructions may include the other trees in different positions or other buildings. Also, the input does not need to be a continuous line. Depending on where the obstructions are, different markings may be made. Also, in one example, shade calculator 102 may automatically analyze the first image to determine the markings.

FIG. 2B depicts a simplified flowchart 250 of a method for defining the distance to a set of obstructions according to one embodiment. At 252, shade calculator 102 receives the first image. Shade calculator 102 may receive the first image from a screen shot of a site plan, or may determine the first image through a service, such as a mapping service is used to generate an aerial image of a location. For example, the site location, such as an address of a house, may be input into a mapping service and the mapping service returns an aerial view of the site location to shade calculator 102.

At 254, shade calculator 102 overlays a scaled 3-D model of the structure in which the solar installation will be installed. In one embodiment, a third party may provide the 3-D model for the structure. In other embodiments, a user may build the 3-D model of the structure, or shade calculator 102 may automatically generate the 3-D model of the structure. As will be discussed in more detail below, the 3-D model of the structure may model the basic outline of the structure including the walls and roof. Further, possible obstructions on the structure may also be modeled, such as the chimney.

At 256, shade calculator 102 outputs the first image on display 104. This allows a user to review the first image and provide user input defining the distance for the obstructions. Also, the reference is defined in the first image. In one embodiment, the southern direction is used as the reference, but other directions may be used. The southern direction may be defined from the measurement position. Accordingly, at 258, shade calculator 102 receives user input for the set of obstructions. For example, a user may use an input device, such as a stylus or mouse, to input a center line of the set of obstructions on display 104. In one embodiment, a user may draw the center line for the set of obstructions using a touch screen.

At 260, shade calculator 102 calculates the distance and the azimuth from the reference. This information will then be used to generate a model of the set of obstructions as will be described in more detail below.

### Second Image

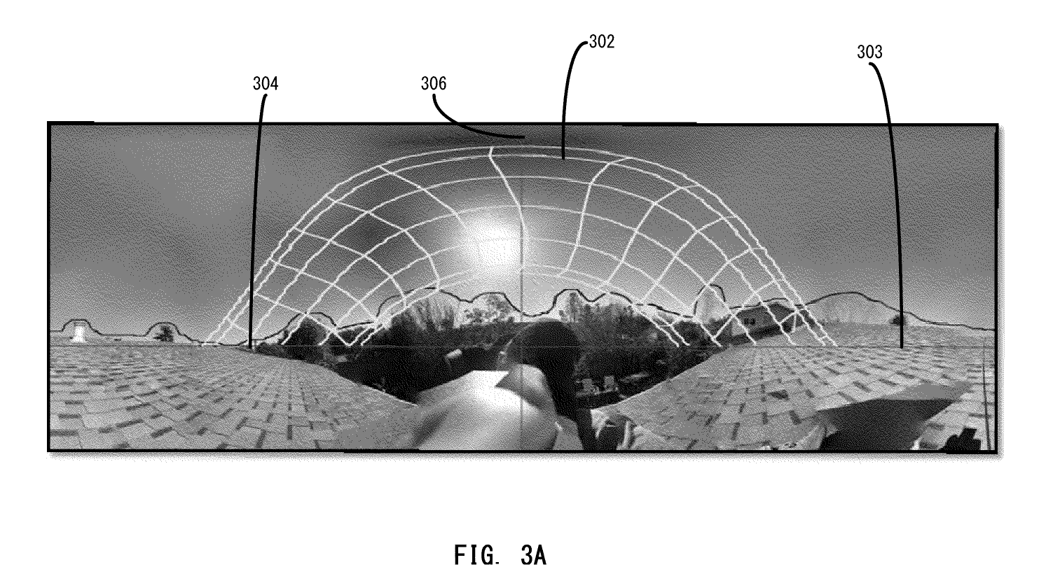

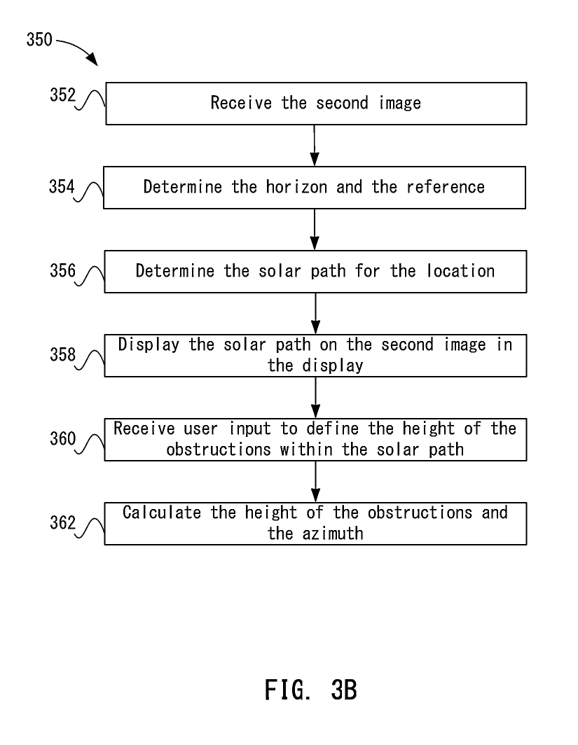

FIG. 3A shows an example of the second image according to one embodiment. As discussed above, the second image may be a panoramic photo taken around the measurement position. In one embodiment, the panoramic photo may be taken at the measurement position shown at 202 in FIG. 2A. However, the panoramic photo may be taken at other points around the measurement position. For example, the panoramic photo may be taken at other points on the roof of the house shown at 204 in FIG. 2A. In some cases, two photos may be used to generate the second image. Also, although a panoramic photo is described, the panoramic photo does not need to be 360°. For example, a 240° panoramic photo may be used. However, obstructions in the 120° that are not shown in the panoramic photo may not be modeled in the subsequent 3-D model and shade calculations may not be as accurate. But, if no obstructions are found in the missing 120°, then the shade calculations may not be impacted. Also, the second image may include multiple photos that depict the obstructions surrounding the measurement position. These multiple photos may be stitched together to form the panoramic photo.

To provide the user input, shade calculator 102 may overlay the Sun's paths for the year in the second image at 302. This shows the user where obstructions may obstruct the Sun's rays during the year. The Sun's path is shown from the horizon, which is marked by a line 303. The user only has to provide user input defining the height of obstructions that are found in the Sun's path, but may provide input for obstructions outside of the path. However, the other obstructions may not obstruct the Sun's rays and thus do not need to be defined.

As shown at 304, shade calculator 102 has received user input that defines the height of obstructions found in the second image. In this embodiment, the user has used a line to outline the top of the obstructions within the Sun's path. Other inputs may also be used to define the height of the obstructions, such as circling the obstructions. Shade calculator 102 then uses the user input to determine the height of the obstructions. For example, shade calculator 102 may calculate the height from the horizon shown at line 303. Also, shade calculator 102 calculates the azimuth from the Southern direction that is marked by a line 306. Each height reading is correlated with an azimuth. For example, shade calculator 102 may record the height of 20 yards at the azimuth of 5 degrees from the Southern direction for one reading. A second reading may be a height of 22 yards at an azimuth of 6 degrees. The height may be recorded as an angle from the horizon. For example, 20 yards may be a 25 degree angle and 22 yards may be a 26 degree angle. The azimuth in both the first image and the second image allows shade calculator 102 to correlate the distance and height together to generate the obstructions. For example, for the azimuth of 5 degrees, the distance of 10 yards and height of 20 yards (or angle of 25 degrees) is recorded, and for the azimuth of 6 degrees, the distance of 12 yards and the height of 22 yards (or angle of 26 degrees) are recorded.

FIG. 3B depicts a simplified flowchart 350 of a method for calculating the height according to one embodiment. At 352, shade calculator 102 receives the second image. Shade calculator 102 may receive the second image via download from a capture device, such as a camera or cellular phone.

At 354, shade calculator 102 determines the horizon and the reference. These were defined by lines 303 and 306 in FIG. 3A, and may be determined automatically or by user input. At 356, shade calculator 102 determines the solar path for the location. The solar path indicates the path of the Sun at time intervals throughout the year and shade calculator 102 determines the path based on the southern direction. At 358, solar calculator 102 displays the solar path on the second image in display 104.

At 360, shade calculator 102 receives user input to define the height of the obstructions within the solar path. For example, a user may use an input device to define the height of the obstructions in the second image. At 362, shade calculator 102 calculates the height of the obstructions and the azimuth. For example, shade calculator 102 may calculate the height from the horizon. The height may be an angle from the measurement position to the height with the horizon as the reference. Other ways of calculating the height may also be used. For each height reading, shade calculator 102 determines the azimuth from the reference. As discussed above, shade calculator 102 uses the azimuth to correlate the height and the distance.

### 3-D Model of the Site

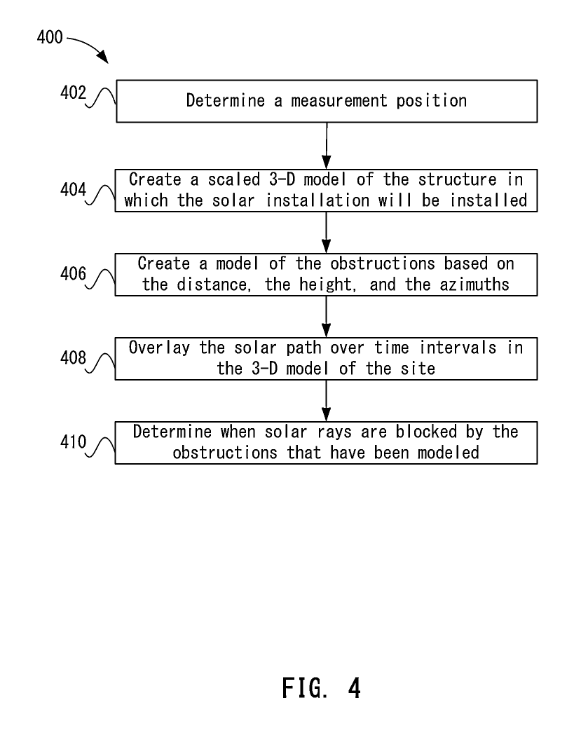

Once the user input has been received, shade calculator 102 may generate the 3-D model of the site. FIG. 4 depicts a simplified flowchart 400 of a method for generating the 3-D model of the site according to one embodiment. At 402, shade calculator 102 determines a measurement position for the solar installation.

At 404, shade calculator 102 creates a scaled 3-D model of the structure in which the solar installation will be installed. The 3-D model of the structure may also include the measurement position. Also, shade calculator 102 may include a solar panel at the installation location on the roof of the house. Because the 3-D model is used, the installation location may be different from the measurement position. Additionally, the 3-D model of the structure may include obstructions that are found on the structure, such as a chimney.

At 406, shade calculator 102 creates a model of the obstructions based on the distance, height, and azimuths determined from user input provided for the first image and the second image. For example, shade calculator 102 uses the correlated distance and height readings based on the common azimuth to build the obstructions. When multiple readings are combined together, an obstruction is formed. In one embodiment, the shape of the obstruction may be a two dimensional model. In other embodiments, shade calculator 102 may build a 3-D model of the obstruction. For example, a 2-D model of the obstruction may follow the shape of the obstruction, such as shade calculator 102 may build a curtain for the obstruction that simulates how a tree would block the Sun's rays at the site. Other shapes may also be used.

Once shade calculator 102 generates the 3-D model of the site, at 408, shade calculator 102 may overlay the solar path over time intervals in the 3-D model of the site. In one example, a ray is generated for each interval to represent the solar light during that interval. Using the Sun's rays, at 410, shade calculator 102 determines when solar rays are blocked by the obstructions that have been modeled. For example, if a ray is blocked by the obstruction from reaching the solar installation, then shade calculator 102 determines that at this point in time or during this time interval, the solar installation does not receive solar light or may see a reduced amount of solar light.

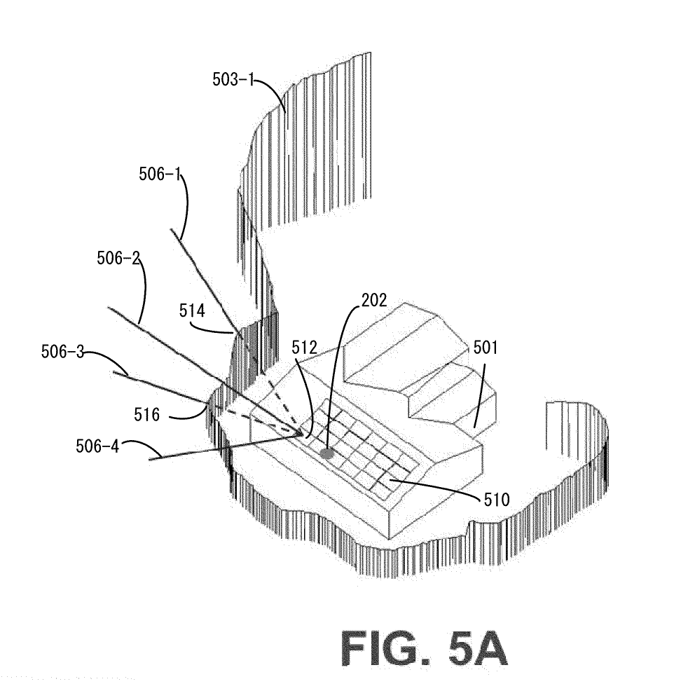

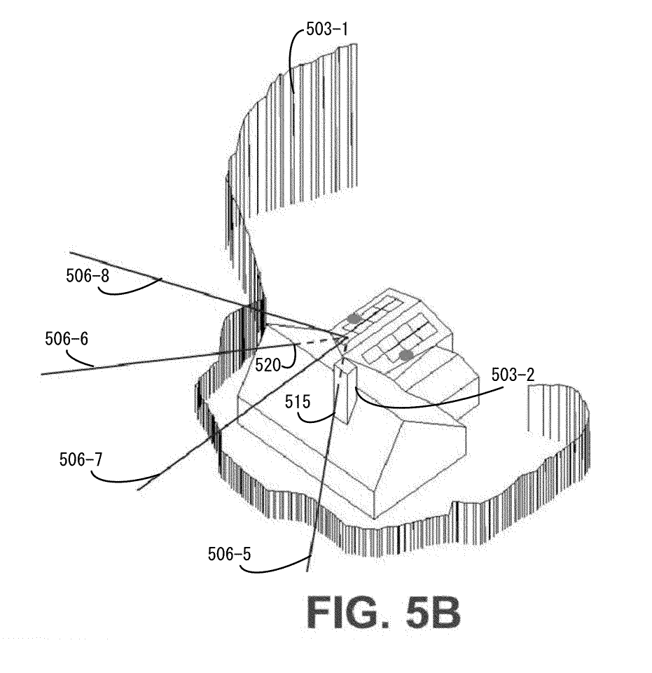

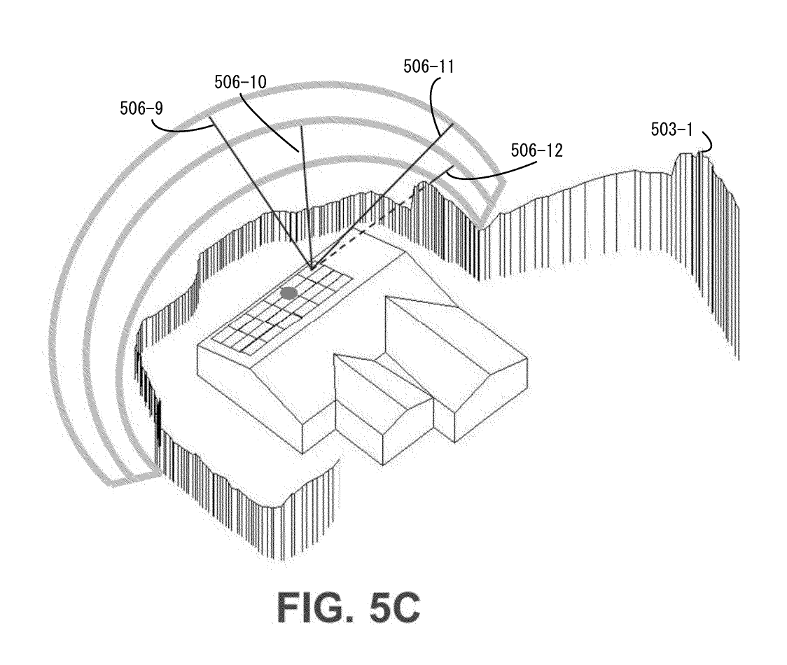

FIG. 5A shows an example of the 3-D model of the site and how rays are determined to be obstructed according to one embodiment. A 3-D model of the structure 501 includes a first measurement position 202 for a solar installation. A solar installation 510 is modeled on the house shown at 204. The installation includes multiple modules in different locations in which shade calculator 102 can calculate the effect of shade. At 512, a shade calculator 102 is performing the shade calculation for a first module. The following calculation can be performed for all the modules, and the results combined. Also, due to the 3-D model being constructed, the installation does not need to be modeled at the measurement position. The installation could be moved at any position in the 3-D model.

Using the reference, shade calculator 102 has modeled the Sun's path at various times during the year. For simplicity purposes, only four rays have been shown; however, other rays can be modeled also. Each ray 506-1-506-4 may be associated with a different time interval, such as multiple hours during the year. In one embodiment, each ray is transformed into an azimuth and compared to the corresponding degree in the 3-D model for the obstructions to see if the obstruction is taller than the Sun position. When an obstruction is taller than the Sun's position, the ray is blocked.

When one of the rays is blocked by an obstruction, shade calculator 102 determines that solar access is blocked for that time interval. For example, ray 506-1 has been blocked by an obstruction 503-1 as shown at 514 and shade calculator 102 determines that solar access is obstructed during this time interval. Also, ray 506-3 is similarly blocked at 516. However, rays 506-2 and 506-4 have not been blocked by obstruction 503-1 and shade calculator 102 determines that solar access is not obstructed during this time interval. This process continues as shade calculator 102 uses 3-D model 500 to determine how many rays at various time intervals are blocked by the obstructions.

Also, the structure may block the Sun's rays. FIG. 5B shows an example of the 3-D model of the structure in which the solar installation will be installed according to one embodiment. In this case, an obstruction 503-2 is shown, which models a chimney on the roof of the structure. In this case, a ray 506-5 has been blocked by obstruction 503-2 at 515.

Further, the slope of the roof is modeled such that when the solar installation is moved to different points on the roof, an obstruction from the roof may be modeled. For example, if the solar installation is moved to a point on the roof, the roof at 520 may block a ray 506-6. Also, rays 506-7 and 506-8 are not blocked by any obstructions.

FIG. 5C shows a more detailed example of the 3-D model of the site according to one embodiment. In this example, the solar path is shown. Rays 506-9, 506-10, and 506-11 are not blocked by obstruction 503-1. However, a ray 506-12 is blocked by obstruction 503-1. As the Sun's rays come from a lower direction, ray 506-12 is blocked.

Using the 3-D model, the solar installation may be moved to a different installation location in the site according to one embodiment. Different rays at different times may be blocked by the obstructions due to the different location. Thus, a different shade calculation may result from moving the solar installation to the different position.

### Shade Calculations

Once shade calculator 102 builds the 3-D model of the site, particular embodiments may perform a shade calculation using different methods. In one embodiment, the first method adjusts production values, and the second method weights production intervals (e.g., hours) to determine the shade percentage. In the first example, shade calculator 102 may adjust production value predictions based on the effect of shade on the solar installation. In the second method, shade calculator 102 may determine a shade percentage that estimates the percentage of solar light seen by the solar installation at a particular installation location over time.

In first method, shade calculator 102 may generate an hourly (or other interval) production model for each module in the solar installation. The interval may depend on the interval used to determine the Sun's rays, such as hourly intervals are both used. The solar array may include multiple modules that generate solar energy. The hourly production model may look at the solar access at the center of each module for each hour throughout the year. If the path of a Sun's ray is blocked by one of the obstructions, shade calculator 102 assumes that the module will not see direct sunlight and will not produce energy. In other embodiments, shade calculator 102 may determine that the module will produce a reduced amount of energy based on the obstruction of the Sun's ray. Then, shade calculator 102 combines (e.g., averages) the data for each module to generate a forecast for the solar installation (e.g., the array). Shade calculator 102 may then output a shade calculation report.

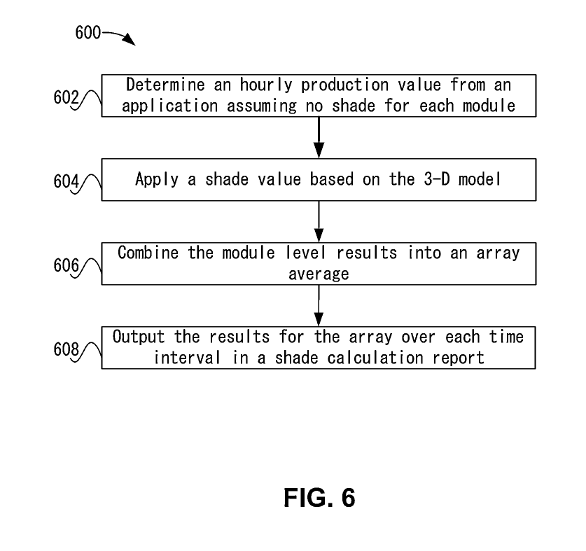

FIG. 6 depicts a simplified flowchart 600 of a method for performing the shade calculation using the first method according to one embodiment. At 602, shade calculator 102 determines an hourly production value from an application assuming no shade for each module. For example, shade calculator 102 may access an application that simulates the amount of energy produced by each module assuming no shade throughout the year. The energy produced may be at certain time intervals, such as 15 minute, 30 minute, hourly, and so on time intervals throughout the year.

At 604, shade calculator 102 applies a shade value based on the 3-D model. For example, the shade value may either indicate that the ray for that time period is obstructed by an obstruction or not obstructed. If the ray for that time interval is obstructed, then shade calculator 102 assumes the energy produced by the module is zero. In other embodiments, shade calculator 102 uses a reduced value from the value assuming no shade. The zero or reduced value is used because an obstruction is obstructing the solar access during that time period and thus it is assumed the module will not be producing energy during that time interval or will be producing a reduced amount.

At 606, shade calculator 102 combines the module level results into an array average. For example, the values for each module are combined into an average over each time interval (e.g., hourly, monthly, or other intervals). At 608, shade calculator 102 then outputs the results for the array over each time interval in a shade calculation report. These results may more accurately estimate the energy production of an array than the results that assume no shade.

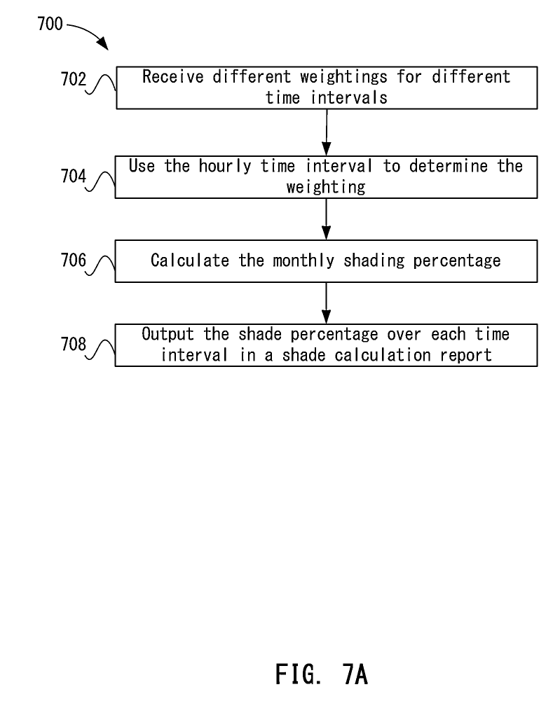

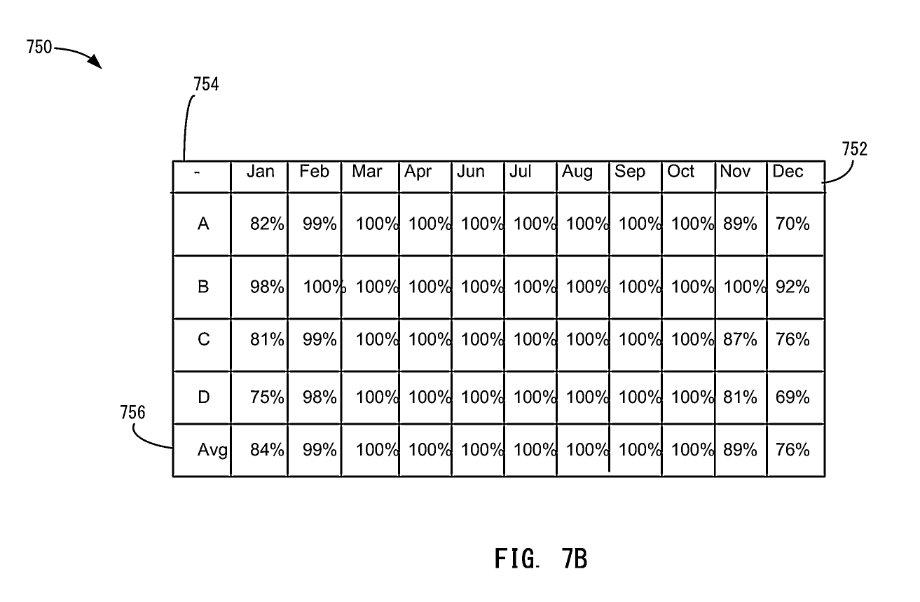

The second method may weight production hours differently based on different time intervals. The result may be a shade percentage that may provide a rough estimation of the amount of sunlight (or shade) seen for an installation location. FIG. 7A depicts a simplified flowchart 700 of the second method for calculating shade according to one embodiment. At 702, shade calculator 102 receives different weightings for different time intervals (e.g., time intervals during the day). For example, a first interval may be “before 8:00 a.m. or after 5:00 p.m.”; a second interval is “8:00 a.m.-9:00 a.m., 4:00 p.m.-5:00 p.m.”; a third interval is “9:00 a.m.-11:00 a.m., 2:00 p.m.-4:00 p.m.”; and a fourth interval is “11:00 a.m.-2:00 p.m.” The different intervals may be assigned different points, such as intervals #1-#4 are assigned 1 point, 2 points, 3 points, and 4 points, respectively.

At 704, shade calculator 102 uses the hourly time interval to determine the weighting. For example, for each time interval in each day of the year, shade calculator 102 determines a shade percentage that is the percentage of rays not blocked during the interval using the 3-D model. Then, the shade percentage is multiplied by the total amount of possible points if no rays were blocked. For example, if 3 rays out of 6 rays in the “before 8:00 a.m. or after 5:00 p.m.” interval are not blocked, then the weighting for that interval is 50%*6 points=3 points. For another interval, if the same calculation was used for the second interval of “8:00 a.m.-9:00 a.m., 4:00 p.m.-5:00 p.m.”, and 3 out of 10 rays were not blocked, then the weighting for this interval is 30%*20 points=6 points. This calculation may be performed for each interval every day throughout the year.

Once shade calculator 102 has calculated all the weightings for the intervals, at 706, shade calculator 102 then calculates the monthly shading percentage (other intervals may also be used, such as weekly). For example, for each month, the amount of points for the month is divided by the total possible number of points for the month. This provides the monthly shade percentage which indicates the percentage of Sun that the solar installation receives. At 708, shade calculator 102 outputs the shade percentage over each time interval in a shade calculation report.

FIG. 7B shows an example 750 of a shade calculation report according to one embodiment. At 752, each month is located in a column. Additionally, different modules A, B, C, and D, are shown in rows 754. For each month, the report shows the shade percentage for each module. The higher the shade percentage, the more solar light the module has access to. For example, a 100% shade percentage means that rays are not obstructed by any obstructions that month. At 756, an average shade percentage for the modules is determined by averaging the shade percentages for all the modules.

### System

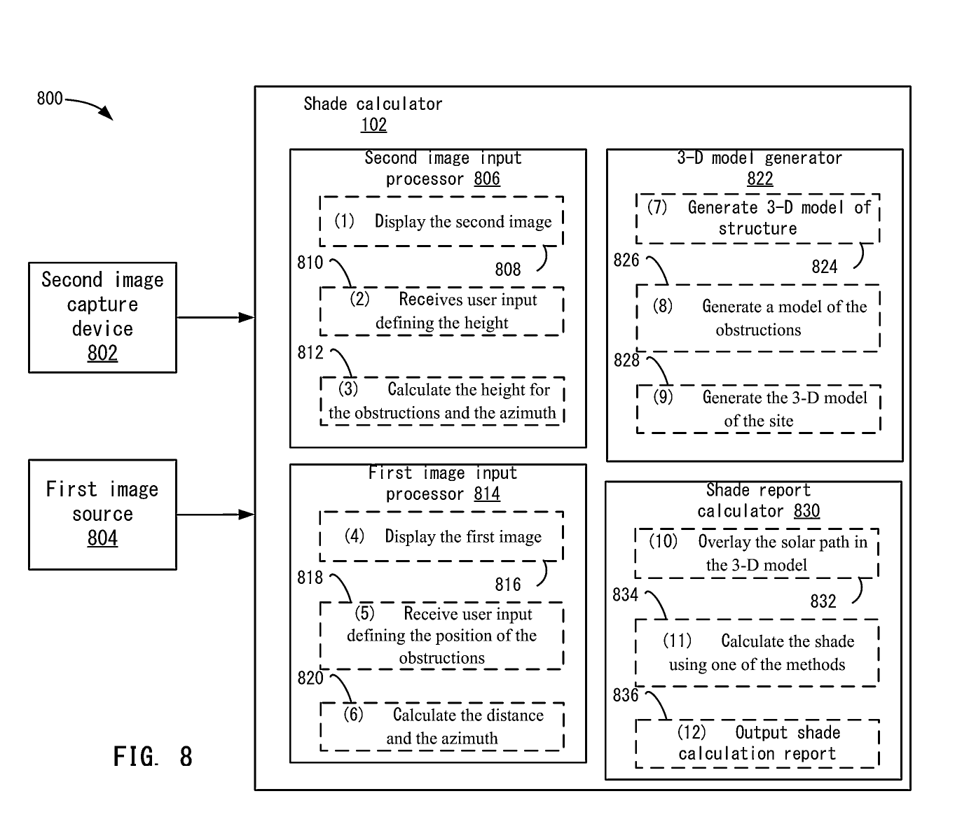

FIG. 8 depicts an example of a system 800 for generating a shade calculation report according to one embodiment. System 800 includes a second image capture device 802 and a first image source 804. Second image capture device 802 may be any device that can be used to capture the second image at the installation location. For example, a user may use a cellular phone or other camera to take a panoramic photo at the measurement position. The panoramic photo may be taken using various methods, such as a device that can receive a cellular phone and automatically take a panoramic photo may be used. In other embodiments, the user may manually take the panoramic photo using the camera or cellular phone. In other embodiments, if a panoramic photo of the site has already been taken, particular embodiments may download that photo.

First image source 804 may be a website or mapping application that has taken the first image. For example, as discussed above, mapping software may have taken an aerial image of the site. In other examples, a capture device may also be used to capture the first image. For example, a camera may capture an aerial view of the site.

In shade calculator 102, a second image input processor 806 may process the second image and also user input for the second image. In a step 1 (reference #808), second image input processor 806 displays the second image. In a step 2 (reference #810), second image input processor 806 receives user input defining the height for the obstructions in the second image. Then, in a step 3 (reference #812), second image input processor 806 calculates the height and azimuth for the obstructions.

For the first image, a first image input processor 814 processes the first image. In a step 4 (reference #816), first image input processor 814 displays the first image. In a step 5 (reference #818), first image input processor 814 receives user input defining the position of the obstructions, such as the center line of the obstructions in the first image. In a step 6 (reference #820), first image input processor 814 calculates the distance from the measurement position to the obstructions and the azimuth.

Once the inputs have been received for the first image and the second image, a 3-D model generator 822 generates the 3-D model. In a step 7 (reference #824), 3-D model generator 822 generates a 3-D model of the structure in which the solar installation will be installed. For example, a 3-D model of the house is generated. In a step 8 (reference #826), 3-D model generator 822 generates a model of the obstructions. The model of the obstructions is generated based on the height, distance, and azimuth determined. In a step 9 (reference #828), 3-D model generator 822 generates the 3-D model of the site using the 3-D model of the house and the model of the obstructions.

Once 3-D model generator 822 has generated the 3-D model, a shade report calculator 830 performs the shade calculation. As described above, different methods may be used to perform the shade calculation. For example, in a step 10 (reference #832), shade report calculator overlays the solar path in the 3-D model. Then, in a step 11 (reference #834), shade report calculator 830 calculates the shade using one of the methods. In a step 12 (reference #836), shade report calculator 830 outputs the shade calculation report.

Accordingly, particular embodiments provide a method for performing a shade calculation based on obstructions that are modeled using a 3-D model. Because a 3-D model is generated, the installation locations of the solar installation may be changed without requiring any new images. In one embodiment, only a first image of an aerial view of the site and a second image providing a panoramic shot of the site may be used to generate the 3-D model. User input defining the height of the obstructions and the distance of the obstructions to the measurement position are used to generate the 3-D model. The cost of generating the report is reduced because a camera or cellular phone can be used to capture the panoramic image. Also, particular embodiments provide a simpler method for determining the shade percentage for different installation locations because multiple pictures from different measurement positions do not have to be taken.

### Computing System

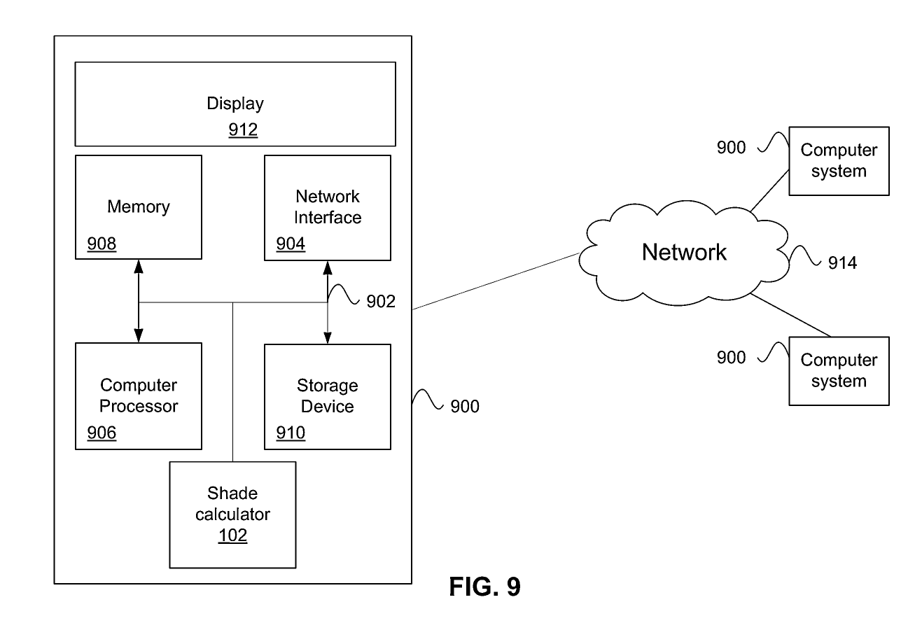

FIG. 9 illustrates an example of a special purpose computer system 900 configured with shade calculator 102 according to one embodiment. Computer system 900 includes a bus 902, network interface 904, a computer processor 906, a memory 908, a storage device 910, and a display 912.

Bus 902 may be a communication mechanism for communicating information. Computer processor 904 may execute computer programs stored in memory 908 or storage device 908. Any suitable programming language can be used to implement the routines of particular embodiments including C, C++, Java, assembly language, etc. Different programming techniques can be employed such as procedural or object oriented. The routines can execute on a single computer system 900 or multiple computer systems 900. Further, multiple processors 906 may be used.

Memory 908 may store instructions, such as source code or binary code, for performing the techniques described above. Memory 908 may also be used for storing variables or other intermediate information during execution of instructions to be executed by processor 906. Examples of memory 908 include random access memory (RAM), read only memory (ROM), or both.

Storage device 910 may also store instructions, such as source code or binary code, for performing the techniques described above. Storage device 910 may additionally store data used and manipulated by computer processor 906. For example, storage device 910 may be a database that is accessed by computer system 900. Other examples of storage device 910 include random access memory (RAM), read only memory (ROM), a hard drive, a magnetic disk, an optical disk, a CD-ROM, a DVD, a flash memory, a USB memory card, or any other medium from which a computer can read.

Memory 908 or storage device 910 may be an example of a non-transitory computer-readable storage medium for use by or in connection with computer system 900. The computer-readable storage medium contains instructions for controlling a computer system to be operable to perform functions described by particular embodiments. The instructions, when executed by one or more computer processors, may be operable to perform that which is described in particular embodiments.

Computer system 900 includes a display 912 for displaying information to a computer user. Display 912 may display a user interface used by a user to interact with computer system 900.

Computer system 900 also includes a network interface 904 to provide data communication connection over a network, such as a local area network (LAN) or wide area network (WAN). Wireless networks may also be used. In any such implementation, network interface 904 sends and receives electrical, electromagnetic, or optical signals that carry digital data streams representing various types of information.

Computer system 900 can send and receive information through network interface 904 across a network 914, which may be an Intranet or the Internet. Computer system 900 may interact with other computer systems 900 through network 914. In some examples, client-server communications occur through network 914. Also, implementations of particular embodiments may be distributed across computer systems 900 through network 914.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
outputting, by a computing device, a first image of a site for a solar installation, the first image in a perspective that allows a distance from a measurement position of the solar installation to a set of obstructions and a set of correlating values to be defined;
receiving, by the computing device, a first input for the first image, the first input used to define the distance from the measurement position of the solar installation to the set of obstructions;
outputting, by the computing device, a second image of the site for the solar installation, the second image in a perspective that allows a height of the set of obstructions and the set of correlating values to be defined;
receiving, by the computing device, a second input for the second image, the second input used to define the height of the set of obstructions;
generating, by the computing device, a three dimensional model of the site that models an installation location of the solar installation and the set of obstructions, wherein the set of obstructions are generated based on the distance, height, and the set of correlating values;
overlaying, by the computing device, a path of solar light in the three dimensional model at a set of time intervals to determine when the set of obstructions obstruct the solar light from the solar installation at the installation location; and
performing, by the computing device, a shade calculation for the solar installation based on the when the set of obstructions obstruct the solar light from the solar installation at the measurement position.

2. The method of claim 1, wherein generating the three dimensional model comprises:
receiving a three dimensional model of a structure on which the solar installation is to be installed; and
placing the solar installation on the structure to determine when the set of obstructions obstruct the solar light from the solar installation.

3. The method of claim 2, wherein the set of obstructions include one or more first obstructions on the structure and one or more second obstructions not associated with the structure.

4. The method of claim 1, wherein the first input comprises a first user input marking the set of obstructions such that the distance from the measurement position can be determined.

5. The method of claim 4, wherein the second input comprises a second user input marking the set of obstructions such that the height of the set of obstructions can be determined.

6. The method of claim 5, wherein generating the three dimensional model of the site comprises:
for each correlating value in the set of correlating values, determining corresponding height and distance values from the first user input and the second user input, respectively; and
generating the set of obstructions using the corresponding height and distance values.

7. The method of claim 1, wherein the perspective of the first image comprises an aerial view of the site and the perspective of the second image comprises a photo taken at the site.

8. The method of claim 1, wherein performing the shade calculation comprises:
determining a solar production value assuming no obstruction for the solar installation for the set of time intervals;
determining when the set of obstructions obstruct the solar light from the solar installation at the installation location for the set of time intervals, wherein the solar production value is adjusted for a time interval when the set of obstructions obstruct the solar light; and
outputting the solar production values including the adjustments for the set of time intervals.

9. The method of claim 1, wherein performing the shade calculation comprises:
determining when the set of obstructions obstruct the solar light from the solar installation at the installation location for the set of time intervals;
determining a weighted value when no obstruction exists for the solar installation for a time interval in the set of time intervals, wherein different time intervals are weighted differently; and
determining a shade percentage using the weighted values for the set of time intervals that represents a percentage of solar light not obstructed by the set of obstructions.

10. The method of claim 1, wherein the set of correlating values comprises azimuth values determined from a reference that is set in the first image and the second image

11. A non-transitory computer-readable storage medium containing instructions, that when executed, control a computer system to be configured for:
outputting a first image of a site for a solar installation, the first image in a perspective that allows a distance from a measurement position of the solar installation to a set of obstructions and a set of correlating values to be defined;
receiving a first input for the first image, the first input used to define the distance from the measurement position of the solar installation to the set of obstructions;
outputting a second image of the site for the solar installation, the second image in a perspective that allows a height of the set of obstructions and the set of correlating values to be defined;
receiving a second input for the second image, the second input used to define the height of the set of obstructions;
generating a three dimensional model of the site that models an installation location of the solar installation and the set of obstructions, wherein the set of obstructions are generated based on the distance, height, and the set of correlating values;
overlaying a path of solar light in the three dimensional model at a set of time intervals to determine when the set of obstructions obstruct the solar light from the solar installation at the installation location; and
performing a shade calculation for the solar installation based on the when the set of obstructions obstruct the solar light from the solar installation at the measurement position.

12. The non-transitory computer-readable storage medium of claim 11, wherein generating the three dimensional model comprises:
receiving a three dimensional model of a structure on which the solar installation is to be installed; and
placing the solar installation on the structure to determine when the set of obstructions obstruct the solar light from the solar installation.

13. The non-transitory computer-readable storage medium of claim 11, wherein the first input comprises a first user input marking the set of obstructions such that the distance from the measurement position can be determined.

14. The non-transitory computer-readable storage medium of claim 11, wherein the first input comprises a first user input marking the set of obstructions such that the distance from the measurement position can be determined.

15. The non-transitory computer-readable storage medium of claim 14, wherein the second input comprises a second user input marking the set of obstructions such that the height of the set of obstructions can be determined.

16. The non-transitory computer-readable storage medium of claim 15, wherein generating the three dimensional model of the site comprises:
for each correlating value in the set of correlating values, determining corresponding height and distance values from the first user input and the second user input, respectively; and
generating the set of obstructions using the corresponding height and distance values.

17. The non-transitory computer-readable storage medium of claim 11, wherein the perspective of the first image comprises an aerial view of the site and the perspective of the second image comprises a photo taken at the site.

18. The non-transitory computer-readable storage medium of claim 11, wherein performing the shade calculation comprises:
determining a solar production value assuming no obstruction for the solar installation for the set of time intervals;
determining when the set of obstructions obstruct the solar light from the solar installation at the installation location for the set of time intervals, wherein the solar production value is adjusted for a time interval when the set of obstructions obstruct the solar light; and
outputting the solar production values including the adjustments for the set of time intervals.

19. The non-transitory computer-readable storage medium of claim 11, wherein performing the shade calculation comprises:
determining when the set of obstructions obstruct the solar light from the solar installation at the installation location for the set of time intervals;
determining a weighted value when no obstruction exists for the solar installation for a time interval in the set of time intervals, wherein different time intervals are weighted differently; and
determining a shade percentage using the weighted values for the set of time intervals that represents a percentage of solar light not obstructed by the set of obstructions.

20. An apparatus comprising:
one or more computer processors; and
a non-transitory computer-readable storage medium comprising instructions, that when executed, control the one or more computer processors to be configured for:
outputting a first image of a site for a solar installation, the first image in a perspective that allows a distance from a measurement position of the solar installation to a set of obstructions and a set of correlating values to be defined;
receiving a first input for the first image, the first input used to define the distance from the measurement position of the solar installation to the set of obstructions;
outputting a second image of the site for the solar installation, the second image in a perspective that allows a height of the set of obstructions and the set of correlating values to be defined;
receiving a second input for the second image, the second input used to define the height of the set of obstructions;
generating a three dimensional model of the site that models an installation location of the solar installation and the set of obstructions, wherein the set of obstructions are generated based on the distance, height, and the set of correlating values;
overlaying a path of solar light in the three dimensional model at a set of time intervals to determine when the set of obstructions obstruct the solar light from the solar installation at the installation location; and
performing a shade calculation for the solar installation based on the when the set of obstructions obstruct the solar light from the solar installation at the measurement position.
